(19) United States
(12) Patent Application Publication
(10) Pub. No.: US 2011/0104508 A1
(43) Pub. Date: May 5, 2011

(54) ADHESIVE FOR BONDING TO FLEXIBLE POLYMER SURFACES

(75) Inventors: Yee Yang Wang, Novi, MI (US); Arthur Francis Cawley, Lake Orion, MI (US); Barbara Jean Walter, Harper Woods, MI (US)

(73) Assignee: Dow Global Technologies Inc.

(21) Appl. No.: 13/002,408

(22) PCT Filed: Aug. 21, 2009
(86) PCT No.: PCT/US2009/054562

§ 371 Date: Jan. 3, 2011

Related U.S. Application Data
(60) Provisional application No. 61/092,934, filed on Aug. 29, 2008.

(51) Int. Cl. B32B 27/36; B32B 7/12; C09J 153/00

(52) U.S. Cl. 428/522; 156/327; 525/94; 524/451; 524/426; 524/505

(57) ABSTRACT

This invention relates to stabilized polymerizable compositions comprising compounds containing moieties capable of free radical polymerization and organoborane initiators capable of initiating free radical polymerization and adhesives based on such compositions. In another embodiment the invention relates to a method of polymerizing compounds containing moieties capable of free radical polymerization and to methods of bonding substrates (including flexible substrates) using such compositions. The invention also relates to coatings, laminates, and components including these compositions.

### CLAIM OF PRIORITY

This application claims the benefit of the filing date of U.S. Provisional Application No. 61/092,934 filed on Aug. 29, 2008, the content of which is hereby incorporated by reference in its entirety.

### FIELD OF THE INVENTION

This invention relates to stabilized polymerizable compositions comprising compounds containing moieties capable of free radical polymerization and organoborane initiators capable of initiating free radical polymerization and adhesives based on such compositions. In another embodiment the invention relates to a method of polymerizing compounds containing moieties capable of free radical polymerization and to methods of bonding substrates (including flexible substrates) using such compositions.

### BACKGROUND OF THE INVENTION

Low surface energy olefins such as polyethylene, polypropylene, thermoplastic olefins (i.e., TPOs), and polytetrafluoroethylene have a variety of attractive properties in a variety of uses, such as toys, automobile parts, furniture applications and the like. Because of the low surface energy of these plastic materials, it is very difficult to find adhesive compositions that bond to these materials. The commercially available adhesives that are used for these plastics require time consuming or extensive pretreatment of the surface before the adhesive will bond to the surface. Such pretreatments include corona treatment, flame treatment, the application of primers, and the like. The requirement for extensive pretreatment of the surface results in significant limitations to designers (e.g., designers of automobile components, toys, furniture and the like).

A series of patents issued to Skoultchi (U.S. Pat. Nos. 5,106,928; 5,143,884; 5,286,821; 5,310,835 and 5,376,746 (all incorporated herein by reference)) disclose a two-part initiator system that is useful in acrylic adhesive compositions. The first part of the two-part system includes a stable organoborane amine complex and the second part includes a decomplexer (i.e., a destabilizer) or activator such as an organic acid or an aldehyde. The adhesive compositions are disclosed to be useful in structural and semi-structural adhesive applications, such as speaker magnets, metal to metal bonding, automotive glass to metal bonding, glass to glass bonding, circuit board component bonding, bonding select plastics to metal, glass to wood, etc. and for electric motor magnets. Zharov, et al. discloses in a series of US patents (U.S. Pat. No. 5,539,070; U.S. Pat. No. 5,690,780; and U.S. Pat. No. 5,691,065 (all incorporated herein by reference)) polymerizable acrylic compositions which are particularly useful as adhesives wherein organoborane amine complexes are used to initiate cure. Pocius in a series of patents (U.S. Pat. No. 5,616,796; U.S. Pat. No. 5,621,143; U.S. Pat. No. 5,681,910; U.S. Pat. No. 5,686,544; U.S. Pat. No. 5,718,977; and U.S. Pat. No. 5,795,657 (all incorporated herein by reference)) disclose amine organoborane complexes with a variety of amines such as polyoxyalkylene polyamines and polyamines which are the reaction product of diprimary amines and compound having at least two groups which react with a primary amine. Pocius (U.S. Pat. No. 5,686,544) discloses a composition comprising an organoborane polyamine complex, polyol and an isocyanate decomplexing agent. Efforts to improve upon the foregoing have been made, as illustrated in Kendall et al., U.S. Pat. No. 6,630,555 and Kneafsey et al., U.S. Patent Publications 2003/0226472 and 2004/0068067 disclose quaternary boron salts which may be used as initiators for the polymerization in adhesive compositions. It is disclosed that these complexes are good for initiating polymerization of an adhesive that bonds to low surface energy substrates.

Jialanella and Ristoski (U.S. Pat. No. 7,247,596 issued on Jul. 24, 2007), incorporated herein by reference, discloses adhesive compositions which adhere to some low surface energy substrates.

Notwithstanding the advancements of U.S. Pat. No. 7,247,596, there remains a need in the art for adhesives for bonding to substrates having a low surface energy; are flexible, or both (such as thermoplastic olefins); adhesives that are thermally stable at, or near, ambient temperatures and which will undergo polymerization when the user desires; adhesives that can be mixed using existing commercial equipment (e.g., having a mix ratio of 4:1 or less); or any combination thereof. There is also a need for improved methods for bonding a substrate that has a low surface energy, is flexible, or both, to another substrate, preferably without the need for extensive or costly pretreatment, so that the bond between the substrates is relatively strong (e.g., the bond is characterized by a high lap shear strength),

### SUMMARY OF THE INVENTION

One aspect of the invention is a polymerizable adhesive composition for bonding to a thermoplastic olefin (TPO) comprising an organoboron compound capable of forming a free radical generating species; an organic acid; one or more compounds that undergo a free radical polymerization; and a monoalkenyl arene block copolymer; wherein the one or more compounds that undergo a free radical polymerization optionally includes methyl methacrylate at a concentration less than about 80 percent based on the total weight of the compounds that undergo a free radical polymerization; wherein the monoalkenyl arene block copolymer is present at a concentration greater than about 3 wt percent, based on the total weight of the polymerizable adhesive composition, and the monoalkenyl arene block copolymer has one or more blocks including a monoalkenyl arene and one or more blocks including a conjugated diene; and wherein the adhesive composition upon curing for 6 days at about 20° C. when applied to a thermoplastic polyolefin exhibits a lap shear strength greater than about 1.8 MPa tested according to ASTM 3163 with a bondline of about 254 μm. This aspect of the invention may be further characterized by one or any combination of the following: the adhesive composition is a two-part adhesive composition including a first part and a second part; the organoboron compound is in the first part; the organic acid is in the second part; the one or more compounds that undergo a free radical polymerization is in the first part, the second part, or both; and the monoalkenyl arene block copolymer is in the first part, the second part, or both; the adhesive composition is a one-part adhesive composition; the one or more compounds that undergo a free radical polymerization includes one or more ester of an unsaturated carboxylic acid, and from about 1 to about 10 weight percent based on the total weight of the composition of a polybutadiene oligomer having a terminal acrylate functionality; or the organoboron compound includes an organoborane amine complex.

Another aspect of the invention is directed at a method of polymerization comprising contacting the components of the polymerization composition of a two-part compositions, such as a two-part composition described herein, having two or more compounds capable of free radical polymerization, under conditions such that the two or more compounds capable of free radical polymerization undergo polymerization. This method of polymerization may further be characterized by one or both of the following: the polymerization occurs at an ambient temperature; or the process further comprises a step of heating the composition.

Another method aspect of the invention is directed at a method of bonding together a first substrate and a second substrate which comprises: i) contacting the first part and the second part of the any of two-part polymerizable compositions described herein under conditions such that polymerization is initiated; ii) contacting the adhesive composition with the first and second substrate; iii) positioning the first and second substrates such that the composition is interposed between the substrates; iv) allowing the composition to polymerize (e.g., cure) so as to bind the substrates together; wherein the first substrate, the second substrate, or both comprises a thermoplastic having a flexural modulus less than about 1500 MPa (e.g., less than about 1200 MPa) as measured according to ISO 178 at a rate of 2 mm/min.

Yet another aspect of the invention is directed at a method of coating a thermoplastic polyolefin substrate comprising the steps of: contacting the components of the composition of any of two-part polymerizable compositions described herein; contacting the contacted composition with one or more surfaces of a substrate; and allowing the contacted composition to cure on the surface of the substrate.

A further aspect of the invention is directed at a laminate comprising at least two substrates having disposed between the substrates and bound to each substrate any of the polymerizable adhesive composition described herein.

Yet another method aspect of the invention is directed towards a method of modifying the surface of a low energy polymer including the steps of contacting any of the polymerizable adhesive compositions described herein with at least a portion of the surface of the low surface energy polymer; and causing the organoboron compound to convert to a free radical generating species thereby initiating a polymerization of at least one compound in the composition such that the polymer formed is on the surface of the low surface energy polymer.

The compositions and methods of the invention result in surprisingly strong adhesion to substrates that are flexible, have a high surface energy, or both, such as a thermoplastic polyolefins.

### DETAILED DESCRIPTION OF THE INVENTION

The polymerizable compositions for bonding to a flexible low surface energy substrate, such as a thermoplastic polyolefin (TPO), may include an organoboron compound capable of forming a free radical generating species (i.e., forms a free radical generating species), one or more compounds capable of free radical polymerization (i.e., undergo a free radical polymerization), an organic acid, and at least 3 weight percent of a monoalkenyl arene block copolymer based on the total weight of the polymerizable composition. The polymerizable composition may have a first part (e.g., a resin part) and a second part (e.g., a hardener part). As such, the polymerizable composition (i.e., the polymerizable adhesive compositions) may be a two-part polymerizable adhesive composition. The organoboron compound may be in the first part and the organic acid may be in the second part. The one or more compounds capable of free radical polymerization (i.e., undergo a free radical polymerization upon mixing the first part and the second part) and the styrene block copolymer may be in the first part, the second part, or both. The one or more compounds that undergo a free radical polymerization may optionally include methyl methacrylate at a concentration less than about 80 weight percent based on the total weight of the compounds that undergo a free radical polymerization. The monoalkenyl arene block copolymer may be present at a concentration greater than about 3 weight percent, preferably greater than about 6.5 weight percent, based on the total weight of the composition and include a block copolymer having one, two or more blocks including a monoalkenyl arene and one or more blocks including a conjugated diene or derivative thereof. Upon mixing the first and the second part, the organoboron compound forms a free radical generating species and causes the compound(s) capable of free radical polymerization to undergo a free radical polymerization. Such compositions may exhibit a lap shear strength greater than about 1.8 MPa as measured according to ASTM 3163 after curing for 6 days at a temperature of about 20° C. using a bondline of about 254 μm (10 mil) and substrates of a TPO containing at least about 5 weight percent, preferably at least 10 weight percent elastomer.

### Organoboron Compound

The polymerizable compound may contain an initiator (i.e., the organoboron compound capable of forming a free radical generating species) such as an initiator described by Jialanella et. al. in U.S. Pat. No. 7,247,596, column 4, line 4 to column 7, line 37, incorporated herein by reference. The polymerization initiator is an organoboron containing compound which is capable of forming a trivalent organoboron compound. In a preferred embodiment, the free radical generating species is a trivalent organoboron compound free radical generating species. Preferred boron containing compounds are tetravalent in that they have four bonds to the boron of which at least three are covalent and one may be covalent or in the form of an electronic association with a complexing agent. The free radical generating species, such as a trivalent boron compound, is formed when the boron containing compound is contacted with another substance, referred to herein as a decomplexing agent or initiator. The free radical generating species generates free radicals by reacting with environmental oxygen. In the embodiment wherein the boron containing compound is tetravalent such contacting causes the abstraction of one of the ligands bonded to or complexed to the boron atom to convert it to a trivalent borane. Free radical containing species is a compound that contains or generates free radicals under polymerization conditions. The decomplexing agent or initiator can be any compound which reacts with the complexing agent or which abstracts a cation from the boron containing compound. Preferably, the boron containing compound is an organoborate (e.g., an organoborate salt) or an organoborane complex (e.g., an organoborane amine complex).

An organoborate is a salt of a positive cation and an anionic tetravalent boron. Any organoborate which can be converted to an organoborane by contact with a decomplexing agent or initiator may be used. One class of preferred organoborates, (also known as quaternary boron salts) are disclosed in Kneafsey et al., U.S. 2003/0226472 and Kneafsey et al., U.S. 2004/0068067, both incorporated herein by reference. In another embodiment, the organoborate is an internally blocked borate as disclosed in Kendall et al., U.S. Pat. No. 6,630,555, incorporated herein by reference. Disclosed in this patent are four coordinate internally blocked borates wherein the boron atom is part of a ring structure further containing an oxa or thio-moiety. The term “internally blocked” in reference to the organoborates described herein means a four coordinate boron atom being part of an internal ring structure bridged across two of the four boron coordinates or valences. Internal blocking includes a single ring or a two-ring structure where boron is part of one or multi-ring structures.

In the embodiment where the organoborane compound is in the form of an amine complex, the free radical generating species used in the invention is a trialkyl borane or an alkyl cycloalkyl borane (i.e., the organoborane amine complex may contain a trialkyl borane or an alkyl cycloalkyl borane). Preferably such borane corresponds to:

BR¹)₃

wherein B represents Boron; and R¹ is separately in each occurrence a C₁-C₁₀ to alkyl, C₃-C₁₀ cycloalkyl, or two or more of R¹ may combine to form a cycloaliphatic ring. Preferably R¹ is C₁-C₄ alkyl, even more preferably C₂-C₄ alkyl, and most preferably C₃-C₄ alkyl. Among preferred organoboranes are triethyl borane, tri-isopropyl borane and tri-n-butylborane.

In the embodiment wherein the organoboron compound is an organoborane amine complex, the organoborane is a trivalent organoborane and the amine can be any amine which complexes reversibly with the organoborane. Such complexes are represented by the formula

BR¹)₃Am

wherein R¹ is described hereinbefore and Am is an amine.

In the embodiment where the organoboron compound is an organoborane amine complex, the amines used to complex the organoborane compound can be any amine or mixture of amines which complex the organoborane and which can be decomplexed when exposed to a decomplexing agent or exposed to elevated temperatures. The desirability of the use of a given amine in an amine/organoborane complex can be calculated from the energy difference between the Lewis acid-base complex and the sum of energies of the isolated Lewis acid (organoborane) and base (amine) known as binding energy, as disclosed in Jialanella et. al., U.S. Pat. No. 7,247,596, column 5, line 60 to column 6, line 28 (incorporated herein by reference).

Binding Energy=−[Complex Energy−(Energy of Lewis Acid+Energy of Lewis base)]

Preferred amines include the primary or secondary amines or polyamines containing primary or secondary amine groups, or ammonia as disclosed in Zharov U.S. Pat. No. 5,539,070 at column 5, lines 41 to 53, incorporated herein by reference, Skoultchi U.S. Pat. No. 5,106,928 at column 2, lines 29 to 58, incorporated herein by reference, and Pocius U.S. Pat. No. 5,686,544 at column 7, line 29 to Column 10, line 36, incorporated herein by reference; ethanolamine, secondary dialkyl diamines or polyoxyalkylenepolyamines; and amine terminated reaction products of diamines and compounds having two or more groups reactive with amines as disclosed in Deviny U.S. Pat. No. 5,883,208 at column 7, line 30 to column 8 line 56, incorporated herein by reference. With respect to the reaction products described in Deviny the preferred diprimary amines include alkyl diprimary amines, aryl diprimary amines, alkylaryl diprimary amines and polyoxyalkylene diamines; and compounds reactive with amines include compounds which contain two or more moieties of carboxylic acids, carboxylic acid esters, carboxylic acid halides, aldehydes, epoxides, alcohols and acrylate groups. Preferred amines described in Deviny include n-octylamine, 1,6-diaminohexane (1,6-hexane diamine), diethylamine, dibutyl amine, diethylene triamine, dipropylene diamine, 1,3-propylene diamine(1,3-propane diamine), 1,2-propylene diamine, 1,2-ethane diamine, 1,5-pentane diamine, 1,12-dodecanediamine, 2-methyl-1,5-pentane diamine, 3-methyl-1,5-pentane diamine, triethylene tetraamine and diethylene triamine. Preferred polyoxyalkylene polyamines include polyethyleneoxide diamines, polypropyleneoxide diamines, triethylene glycol propylene diamine, polytetramethyleneoxide diamine and polyethyleneoxidecopolypropyleneoxide diamines.

In one preferred embodiment, the borane comprises a trialkyl borane or an alkyl cycloalkyl borane and the amine comprises a primary amine; a secondary amine; a polyamine having primary or secondary amines or both; ammonia; polyoxyalkylene amines; the reaction product of a diamine and a difunctional compound having moieties which react with an amine, wherein the reaction product has terminal amine groups; aryl amines; heterocyclic amines; a compound having an amidine structural component; aliphatic heterocycles having at least one secondary nitrogen in the heterocyclic ring wherein the heterocyclic compound may also contain one or more additional secondary or tertiary nitrogen atoms, oxygen atoms, sulfur atoms, or double bonds in the heterocycle; alicyclic compounds having bound to the alicyclic ring one or more substituents containing an amine moiety; conjugated imines; or mixtures thereof as described in Sonnenschein et al., U.S. Patent Publication 2002/0028894 at paragraphs 0018 to 0045, incorporated herein by reference. Without limitation, exemplary organoboron compounds include a complex of tri-n-butyl borane and methoxypropyl amine (TNBB/MOPA), a complex of triethylborane and methoxypropyl amine (TEB/MOPA), or mixtures.

In another preferred embodiment, the amine further contains siloxane, that it is an amino siloxane. Any compound with both amine and siloxane units wherein the amine has sufficient binding energy as described hereinbefore with the organoborane, may be used. Preferably, the siloxane moiety will permit this component to participate in polymerization of siloxane monomers, oligomers, and/or polymers when present. The siloxane containing monomers, oligomers, and/or polymers can be any compound which contains silicone. Preferably, the siloxane compound has reactive functionality. Preferable reactive functionalities include hydride, olefinic unsaturation, hydroxyl and hydrolyzable moieties that hydrolyze to form a silanol moiety. Preferred amine silanes are disclosed in Sonnenschein et al., U.S. Pat. No. 6,777,512, issued Aug. 17, 2004 at column 8, line 37 through column 11, line 40, incorporated herein by reference.

In the embodiment where the organoboron compound is an organoborane amine complex, the equivalent ratio of amine compound(s) to borane compound in the complex is relatively important. An excess of amine is preferred to enhance the stability of the complex and in the embodiment where the decomplexing agent is an isocyanate functional compound to react with the isocyanate functional compound thereby resulting in the presence of polyurea in the final product. The presence of polyurea improves the high temperature properties of the composition.

The organoboron compound may be present at a concentration greater than 0.1 weight percent, preferably greater than about 1 weight percent, more preferably greater than about 2 weight percent, and most preferably greater than about 4 weight percent based on the total weight of the composition. The organoboron compound may be present at a concentration less than 20 weight percent, preferably less than about 10 weight percent, more preferably less than about 8 weight percent, and most preferably less than about 6 weight percent based on the total weight of the composition.

### Decomplexing Agent

As described above, the adhesive composition may also contain a decomplexing agent or initiator. Such an agent may function by reacting with the boron containing compound (e.g., the organoborane complex) and abstracts a cation from the boron containing compound or in the case of a tetravalent boron compound the initiator may causes the abstraction of one of the ligands bonded to or complexed to the boron atom to convert it to a trivalent borane. After reacting with the decomplexing agent, the boron containing compound may become a compound that contains or generates free radicals under polymerization conditions. The decomplexing agent may include or consist essentially of mineral acids, organic acids, Lewis acids, isocyanates, acid chlorides, sulphonyl chlorides, aldehydes, and the like, or any combination thereof. Without limitation, organic acids suitable for use as a decomplexing agent may include an acrylic acid such as acrylic acid, methacrylic acid, or both. The decomplexing agent may be present at any concentration suitable for initiating the free radical polymerization reaction. For example, the decomplexing agent (e.g., the organic acid) may be present at a concentration greater than about 0.05 weight percent, preferably greater than 0.5 weight percent, more preferably greater than about 1 weight percent and most preferably greater than about 2 weight percent based on the total weight of the composition. The decomplexing agent (e.g., the organic acid) may be present at a concentration less than about 10 weight percent, preferably less than about 8 weight percent, more preferably less than about 7 weight percent, and most preferably less than about 6 weight percent based on the total weight of the composition.

Generally, the parts of the two-part composition are contacted at or near ambient temperatures. Further, the contacted compositions are preferably contacted with substrates at or near ambient temperatures. Ambient temperatures are the temperatures of the surrounding environment at the time of contacting provided the composition is capable of reacting at those surrounding temperatures. Preferably contacting at ambient temperatures means no external heating or cooling is involved. Preferably, ambient temperatures are greater than about 0° C., more preferably about 5° C. or greater, even more about 15° C. or greater, and most preferably about 20° C. or greater. Preferably ambient temperatures are less than about 30° C., and most preferably about 25° C. or less.

Generally the temperature used to initiate the polymerization by forming the compounds capable of forming free radical containing species, for example, by decomplexing an organoborane amine complex, is about 0° C. or greater, preferably about 20° C. and greater, more preferably about 30° C. or greater and most preferably about 50° C. or greater. Preferably the temperature at which thermally initiated polymerization is initiated is about 120° C. or less and more preferably about 100° C. or less. Any heat source that heats the composition to the desired temperature can be used, provided the heat source does not negatively impact the components of the composition or its function. In this manner the composition may be contacted with the substrates either before or after the composition is exposed to heat. If the composition is heated prior to contact with the substrates, the composition should be contacted with the substrates before the composition has polymerized to the point at which the composition is no longer able to adhere to the substrates. It may be necessary in the thermally initiated reaction to control the oxygen content such that there is adequate oxygen to create favorable conditions for radical formation but not so much as to inhibit the polymerization.

Compounds Capable of Free Radical Polymerization

One or more compounds which may undergo a free radical polymerization (i.e., are capable of free radical polymerization) may be used in the polymerizable adhesive compositions. Suitable compounds which may undergo a free radical polymerization include any monomers, oligomers, polymers or mixtures thereof which contain olefinic unsaturation which can polymerize by free radical polymerization. Such compounds are well known to those skilled in the art. Mottus, U.S. Pat. No. 3,275,611 at column 2, line 46 to column 4, line 16 and Sonnenschein et al., U.S. 2002/0028894 at paragraph 47 provides descriptions of such compounds, incorporated herein by reference. Without limitation, the one or more compounds (such as monomers, oligomers, or both) which may undergo a free radical polymerization may include esters of unsaturated carboxylic acids (e.g. the alkyl esters of unsaturated carboxylic acids), such as acrylates, methacrylates, and the like. For example, the esters of unsaturated carboxylic acids may each have at least one acrylate or methacrylate functional group.

Examples of preferable acrylates and methacrylates are disclosed in Skoultchi, U.S. Pat. No. 5,286,821 at column 3, lines 50 to column 6, line 12, incorporated herein by reference and Pocius, U.S. Pat. No. 5,681,910 at column 9, line 28 to column 12, line 25, incorporated herein by reference. More preferred olefinic compounds comprise methyl acrylate, methylmethacrylate, butylmethacrylate, tert-butylmethacrylate, 2-ethylhexyacrylate, 2-ethylhexylmethacrylate, ethylacrylate, isobornylmethacrylate, isobornylacrylate, hydroxyethylmethacrylate, glycidylmethacrylate, tetrahydrofurfuryl methacrylate, alkoxylated tetrahydrofurfuryl methacrylate (e.g., ethoxylated or propoxylated tetrahydrofurfuryl methacrylate), acrylamide, n-methylacrylamide, and other similar acrylate containing monomers. The composition most preferably include one, two, or more of the abovementioned olefinic compounds.

Also useful are the class of acrylate tipped prepolymers. Acrylate tipped polybutadiene prepolymers (e.g., oligomers) are commercially available from Emerald Performance Materials under the tradename Hypro. One such preferred compound is Hypro™ VTB 2000X168. Acrylate tipped polyurethane prepolymers are available commercially from several sources, and prepared by reacting an isocyanate reactive acrylate monomer, oligomer or polymer, such as a hydroxy acrylate, with an isocyanate functional prepolymer. One such preferred compound is CN 973J75 from Sartomer Company, Inc.

Although a single ester of an unsaturated carboxylic acid (e.g., an acrylate or a methacrylate) may be used, the adhesive composition preferably comprises a combination of two, three or more compounds which may undergo a free radical polymerization. Without being bound by theory, the use of a plurality of esters of unsaturated carboxylic acids may provide compounds which advantageously have one or more different property such as different wetting properties, different surface energies, different reactivities, different adhesion characteristics, or different fracture properties.

The amounts of compounds capable of free radical polymerization (such as acrylate and/or methacrylate based compounds) are preferably about 10 percent by weight or greater, more preferably about 15 percent by weight or greater, even more preferably about 20 percent by weight or greater and most preferably about 30 percent by weight or greater based on the total weight of the composition. The amounts of compounds capable of free radical polymerization (such as acrylate and/or methacrylate based compounds) are preferably about 90 percent by weight or less based on the total composition weight, more preferably about 85 percent by weight or less and most preferred 80 percent by weight or less.

Methyl methacrylate may be used in the polymerizable compositions at a concentration less about 80 weight percent, preferably less than about 70 weight percent, more preferably less than about 60 weight percent, even more preferably less than about 50 weight percent, and most preferably less than about 40 weight percent based on the total weight of the compounds which undergo free radical polymerization. Methyl methacrylate may be used in the polymerizable compositions at a concentration of about 0 weight percent or more, preferably about 10 weight percent or more, more preferably about 15 weight percent or more, and most preferably about 20 weight percent or more, based on the total weight of the compounds which undergo free radical polymerization. The polymerizable composition may also be free of methyl methacrylate. If employed, the methyl methacrylate is preferably present only as part of a mixture. For example, the methyl methacrylate may be in a mixture including another ingredient in the adhesive composition, such as an elastomer (e.g., a monoalkenyl arene block copolymer, such as a styrene-butadiene-styrene triblock copolymer).

The polymerizable composition may include an alkoxylated tetrahydrofurfuryl acrylate (e.g., a propoxylated or ethoxylated tetrahydrofurfuryl acrylate, such as a propoxylated tetrahydrofurfuryl acrylate having from 1 to 20 propoxy groups), at a concentration greater than about 0 weight percent and preferably 1 weight percent or greater, based on the total weigh of the polymerizable composition. The concentration of the alkoxylated tetrahydrofurfuryl acrylate may be less than about 10 weight percent, and preferably about 5 weight percent or less, based on the total weight of the polymerizable composition. The polymerizable composition may include methyl methacrylate at a concentration greater than about 0 weight percent, preferably about 10 weight percent or more, more preferably about 15 weight percent or more, and most preferably about 20 weight percent, or more, based on the total weight of the polymerizable composition. The concentration of methyl methacylate may be less than about 50 weight percent, preferably about 40 weight percent or less, more preferably about 35 weight percent or less, and most preferably about 30 weight percent or less, based on the total weight of the polymerizable composition. The polymerizable composition may include tetrahydrofurfuryl acrylate at a concentration greater than about 0 weight percent, and preferably 1 weight percent or more, based on the total weight of the polymerizable composition. The polymerizable composition may include tetrahydrofurfuryl acrylate at a concentration less than about 10 weight percent, preferably about 5 weight percent or less, based on the total weight of the polymerizable composition. The polymerizable composition may include an acrylate or a methacrylate having an oxirane ring (e.g., glycidyl methacrylate) at a concentration greater than about 0 weight percent, preferably about 10 weight percent or more, and more preferably about 20 weight percent or more, based on the total weight of the polymerizable composition. The polymerizable composition may include an acrylate or a methacrylate having an oxirane ring (e.g., glycidyl methacrylate) at a concentration less than about 60 weight percent, preferably about 50 weight percent or less, and more preferably about 45 weight percent or less, based on the total weight of the polymerizable composition. The polymerizable composition may include acrylate tipped alkadiene prepolymer (i.e., an alkadiene oligomer, such as a polybutadiene oligomer, having a terminal acrylate functionality) at a concentration greater than about 0 weight percent, preferably 1 weight percent or more, and more preferably about 2 weight percent or more, based on the total weight of the polymerizable composition. The polymerizable composition may include acrylate tipped alkadiene prepolymer at a concentration less than about 20 weight percent, preferably about 15 weight percent or less, more preferably about 10 weight percent or less, and most preferably about 6 weight percent or less, based on the total weight of the polymerizable composition.

As an example, without limitation, the polymerizable composition may contain one, two, three or four of the compounds selected from the group consisting of methyl methacrylate, an alkoxylated tetrahydrofurfuryl acrylate, an acrylate or methacrylate having an oxirane ring, and an acrylate-tipped alkadiene (e.g., butadiene) prepolymer.

The compositions may also include one or more compounds containing one or more ring opening heterocyclic moieties and a catalyst capable of polymerizing compounds containing ring opening heterocyclic moieties. Examples of suitable compounds containing one or more ring opening heterocyclic moieties, catalysts capable of polymerizing such compounds, and initiators for initiating the ring opening polymerization are described in Jialanella et. al., U.S. Pat. No. 7,247,596, column 7, line 48 to column 10, line 16 (incorporated herein by reference). The composition may also include one or more compounds, oligomers or prepolymers having a siloxane backbone and reactive moieties capable of polymerization as well as catalysts for such reactions as described in Sonnenschein et al., U.S. Pat. No. 6,777,512, issued Aug. 17, 2004 at column 12, line 66 through column 17, line 53, relevant parts incorporated herein by reference, and in Jialanella et. al., U.S. Pat. No. 7,247,596, column 10, line 17 to column 12, line 44.

In compositions using a compound having a siloxane backbone a catalyst may also be used. Such catalysts are described in Jialanella et al., U.S. Pat. No. 7,247,596, at column 11, line 50 to column 12, line 10, incorporated herein by reference. Preferred catalysts are tin catalysts, including dibutyltin diacetate and dibutyl tin dilaurate, tetraalkoxytitanium catalysts, acidic catalysts, and platinum catalysts including chloroplatinic acid and platinum (O)-1,3-divinyl-11,1,3,3-tetramethyldisiloxane complex.

### Monoalkenyl Arene Block Copolymer

The composition may comprise a thermoplastic elastomer which is elastomeric, does not flow at about 20° C., and melts or softens at an elevated temperature. The block copolymer includes at least one “A” block and at least one “B” block, where the “A” and “B” blocks are chemically different (e.g., they may have different monomers, different concentration of monomers, or both). The “A” blocks may be a relatively hard block and the “B” blocks may be a relatively soft block. The block copolymer may contain two blocks (e.g., an A-B diblock copolymer), three blocks (e.g., an A-B-A, or a B-A-B triblock copolymer), more than three blocks, or any combination thereof.

The block copolymer may be a monoalkenyl arene block copolymer where the A block comprises units derived from one or more monoalkenyl arenes. Suitable monoalkenyl arene block copolymers may have a B block that comprises units derived from one or more conjugated dienes. The first block (the A blocks) of the block copolymer generally comprise, in polymeric form, monoalkenyl arenes. The term monoalkenyl arene monomer means herein a compound having an aromatic ring, preferably monocyclic, with an alkenyl moiety bound thereto which is capable of polymerizing under anionic conditions. Preferred monoalkenyl arenes correspond to the formula:

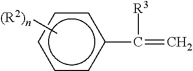

where n is an integer from 0 to 3, R² is an alkyl moiety containing up to 5 carbon atoms and R³ is hydrogen or methyl. Preferred monoalkenyl arenes are styrene or alkyl substituted styrenes such as vinyl toluene (all isomers, alone or in admixture), α-methylstyrene, 4-tertiarybutylstyrene, 4-methylstyrene, 3,5-diethylstyrene, 3,5-di-n-butylstyrene, 4-(4-phenyl-n-butyl)styrene, 2-ethyl-4-benzylstyrene, 4-cyclohexylstyrene, 4-n-propylstyrene, 4-dodecylstyrene, mixtures thereof and the like. More preferred monoalkenyl arenes include styrene, vinyl toluene, α-methylstyrene and mixtures thereof. Even more preferred alkenyl arenes are styrene and mixtures of styrene and α-methylstyrene.

The second block (the B blocks) of the block copolymer generally comprise in polymeric form, conjugated dienes, or the product of at least partially hydrogenating a polymerized conjugated diene. Conjugated dienes useful in this invention include straight- and branched-chain aliphatic hydrocarbons containing two double bonds attached to adjacent carbon atoms. Preferable conjugated dienes contain 4 to 6 carbon atoms and include butadiene, isoprene, 1,3-pentadiene, 1,3-hexadiene, 2,3-dimethylbutadiene and mixtures thereof. More preferably, such conjugated dienes contain from about 4 to about 5 carbon atoms and include, for example, butadiene, isoprene, cis-1,3-pentadiene, trans-1-3-pentadiene and mixtures thereof. The most preferred conjugated dienes are butadiene and isoprene.

Without limitation, the block copolymer may be a monoalkenyl arene block copolymer disclosed in U.S. Pat. No. 5,462,994 (Lo et al., issued Oct. 31, 1995), incorporated herein by reference.

The block copolymer (e.g., the monoalkenyl arene block copolymer) may be a hydrocarbon (e.g., the block copolymer may be substantially free, or entirely free of nitrogen, oxygen, sulfur, silicon or any combination thereof). Such block copolymers may be free of blocks containing acrylonitrile, methacrylate, acrylate, or any combination thereof.

Exemplary block copolymers include styrenic block copolymers, such as a styrene butadiene diblock copolymer, a styrene isoprene diblock copolymer, a styrene ethylene-propylene diblock copolymer, a styrene ethylene-butylene diblock copolymer, a styrene butadiene styrene triblock copolymer, a styrene isoprene styrene triblock, a styrene ethylene-propylene styrene triblock copolymer, a styrene ethylene-butylene triblock copolymer, or any combination thereof. The “B” block may include one or more monomeric repeat units which are initially unsaturated (e.g., a polymerized conjugated diene), but are reacted to partially or completely hydrogenate the monomer segments in the polymer block. For example, a B block may contain butadiene which is completely hydrogenated to produce an ethylene-butylene containing block, or it may be partially hydrogenated to produce a block having both butadiene and ethylene-butylene units. Similarly, a B block may contain isoprene which is completely hydrogenated to produce an ethylene-propylene containing block, or it may be partially hydrogenated to produce a block having both isoprene and ethylene-propylene units.

The monoalkenyl arene block copolymer may include a linear block copolymer, a branched block copolymer, a block copolymer having another structure, such as a star shaped structure containing three, four, or more arms, or any combination thereof. Preferably, the monoalkenyl arene block copolymer includes a linear block copolymer, such as a linear triblock copolymer having two styrene blocks and one conjugated diene block (e.g., a conjugated diene block having a glass transition temperature less than 20° C., preferably less than about 0° C., more preferably less than about −20° C., and most preferably less than about −40° C.). The monoalkenyl arene block copolymer may be characterized by the concentration (unless otherwise defined, measured in weight percent) of monoalkenyl arene units in the copolymer. The monoalkenyl arene concentration (e.g., the styrene concentration) may be greater than about 10 wt percent, preferably greater than about 20 weight percent, and more preferably greater than about 25 weight percent. The monoalkenyl arene concentration (e.g., the styrene concentration) may be less than about 70 weight percent, preferably less than about 60 weight percent, more preferably less than about 50 weight percent, and most preferably less than about 35 weight percent. The concentration of the “B” block (e.g., the butadiene block or the isoprene block), may be greater than about 30 weight percent, preferably greater than about 40 weight percent, more preferably greater than about 50 weight percent and most preferably greater than about 65 weight percent. The concentration of the “B” block may be less than about 90 weight percent, preferably less than about 80 weight percent, and more preferably less than about 75 wt.

The monoalkenyl arene block copolymer may soften and flow at a temperature above the glass transition temperature of the monoalkenyl arene block. Suitable monoalkenyl arene block copolymers may be characterized by a melt flow rate (e.g., as measured according to ASTM D1238 at 200° C., 10.0 kg) greater than about 0.5, preferably greater than about 2.0 and more preferably greater than about 4.0 g/10 min. the styrene block copolymer may have a melt flow rate less than about 250, preferably less than about 50, more preferably less than about 30, and most preferably less than about 15 g/10 min. The monoalkenyl arene block copolymer may have a hardness (e.g., as measured according to ASTM D2240 using a 1 second delay) which is less than the hardness of polystyrene. For example, the monoalkenyl arene block copolymer may have a hardness less than 95, preferably less than 90, more preferably less than 85, and most preferably less than 80 Shore A. The monoalkenyl arene block copolymer may also be characterized by a hardness greater than about 20, preferably greater than about 40, more preferably greater than about 60, and most preferably greater than about 70 Shore A. Without limitation, the monoalkenyl arene block copolymer may be characterized by a tensile stress at 300 percent strain (e.g., as measured according to ASTM D412) greater than about 0.3, preferably greater than about 0.8, more preferably greater than about 1.9, and most preferably greater than about 3 MPa. Suitable monoalkenyl arene block copolymers may also be characterized by a tensile stress at 300 percent strain less than about 12 MPa, preferably less than about 8 MPa, more preferably less than about 6 MPa, and most preferably, less than about 4.5 MPa.

One exemplary monoalkenyl arene block copolymer includes a linear styrene butadiene styrene triblock copolymer having one or any combination of the following characteristics: contains less than about 40 weight percent (e.g., less than about 10 weight percent, preferably less than about 2 weight percent) diblock concentration; has a styrene concentration from about 25 to about 35 weight percent, has a hardness from about 70 to about 85 Shore A, has a tensile stress at 300 percent strain less than about 4.5 MPa, or has a melt flow rate from about 2.0 to about 50 g/10 min. Suitable styrene block copolymers may include styrene butadiene styrene triblock copolymers available from Dexco Polymers (VECTOR™) and others, styrene ethylene-butylene triblock copolymers available from Shell Chemical Co. (KRATON™) and Kuraray America Inc. (SEPTON™), styrene-isoprene-styrene triblock copolymers available from Shell Chemical Co., Dexco Polymers, EniChem, and others, and styrene ethylene-propylene styrene triblock copolymers available from Kuraray America Inc. (SEPTON™).

The concentration of the block copolymer (e.g., the A-B-A triblock copolymer, AB diblock copolymer, or both) may be about 3 weight percent or more, preferably about 4 weight percent or more, more preferably about 5 weight percent or more, and most preferably about 6.5 weight percent or more, based on the total weight of the composition. The concentration of the block copolymer (e.g., the ABA triblock copolymer, A-B diblock copolymer, or both) may be about 45 weight percent or less, preferably about 30 weight percent or less, more preferably about 25 weight percent or less, and most preferably about 18 weight percent or less, based on the total weight of the composition.

The polymerizable composition may be free of chlorine containing elastomers, such as chlorosulfonated polyethylene elastomer. If present the concentration of the chlorine containing elastomer (e.g., the chlorosulfonated polyethylene elastomer) may be 4 weight percent or less, preferably 2 weight percent or less, and most preferably 1 weight percent or less based on the total weight of the composition. For example the concentration of the chlorosulfonated polyethylene elastomer may be from about 0 weight percent to about 4 weight percent based on the total weight of the composition.

### Fillers

The polymerizable composition may also include one or more fillers. In the two-part polymerizable compositions, the filler may be in the first part, the second part, or both. Apportionment of the filler between the first and second part is described later. It is seen that compositions containing one or a plurality of fillers may have surprisingly good adhesion to a thermoplastic polyolefin surface.

The fillers which may be used in the polymerizable compositions include talc, mica, wollastonite, calcium carbonate, barium sulfate, magnesium carbonate, clay, alumina, silica, fumed silica, calcium sulfate, carbon fibers, glass fibers, metal fibers, silica sand, carbon black, titanium dioxide, magnesium hydroxide, zeolite, molybdenum, diatomaceous earth, sericite, white sand, calcium hydroxide, calcium sulfite, sodium sulfate, bentonite, graphite, diatomaceous earth, glass particles, glass beads, nanoparticles of clay, kaolinite, illite, chloritem, smecitite, sepiolite, vermiculite, pyrophyllite, sauconite, saponite, nontronite, montmorillonite, magnesium aluminum silicate, metal carbonates, feldspar, mica, quartz, and mixtures thereof. Suitable fillers may be treated or untreated. Exemplary fillers, without limitation, include a talc, a calcium carbonate, a fumed silica, a clay or any combination thereof. A plurality of these fillers may be used. For example the polymerizable composition may include a fumed silica and a treated (or untreated) calcium carbonate. The filler may be present at a concentration of about 0 weight percent or more, preferably about 1 weight percent or more, and more preferably about 2 weight percent, or more based on the total weight of the polymerizable composition. The filler may be present at a concentration of about 25 weight percent or less, preferably about 17 weight percent or less, more preferably about 15 weight percent or less, and most preferably about 12 weight percent or less based on the total weight of the polymerizable composition. For example, the filler may be present at a concentration from about 0 weight percent to about 25 weight percent, (preferably from about 1 weight percent to about 17 weight percent, and more preferably from about 2 weight percent to about 12 weight percent (e.g., about 6 weight percent) based on the total weight of the polymerizable composition.

### Stabilizers

The compositions of the invention may contain a stabilizing amount of an alicyclic hydroxylamine or a dihydrocarbyl hydroxylamine; or a nitroxyl or nitrile oxide thereof. Stabilizing as used herein refers to preventing polymerization until desired. Generally this means that polymerization is inhibited under normal storage conditions. Normal storage conditions mean storage at a temperature of about 0° C. to about 40° C., wherein the adhesive is stored in a sealed container. A stable composition is one that does not experience undesired viscosity growth during a defined period. Viscosity growth is evidence of polymerization of the monomers present. In a preferred embodiment, a composition is stable if the viscosity does not increase more than 150 percent over a time period of 30 days when stored at temperatures of 40° C. or less, more preferably 100 percent or less over a time period of 30 days and most preferably 50 percent or less over a time period of 30 days.

Dihydrocarbyl hydroxylamines, alicyclic hydroxylamines and nitrile oxides thereof, useful herein include any such compounds which when included in the compositions of this invention improve the stability of the compositions as described herein. Alicyclic hydroxylamine means a nitrogen containing aliphatic heterocycle wherein the nitrogen atom has a hydroxyl moiety bound thereto. The hydrocarbyl groups on the dihydrocarbyl hydroxylamine and the alicyclic hydroxylamines can be substituted with any substituent which does not significantly impact the performance of these additives in formulations of this invention. Preferred dihydrocarbyl hydroxylamines and alicyclic hydroxylamines correspond to the formula (R¹³)₂N—OH wherein R¹³ is independently in each occurrence a hydrocarbyl moiety or the two R¹³ may combine to form a cyclic ring, wherein the hydrocarbyl groups or cyclic ring may be substituted with one or more substituents which do not interfere with the function of the compounds in this invention.

In one embodiment, the nitroxyl or nitrile oxides are illustrated by the formula:

(R⁴)₂—N—O

wherein R⁴ is described above. Preferably R⁴ is independently in each occurrence a C₂₋₃₀ alkyl, alkaryl or aryl moiety or two R⁴ form a C₂₋₃₀ cycloalkyl moiety; more preferably a C₁₀₋₂₀ alkyl, alkaryl or aryl moiety and two R⁴ are C₂₋₇, cycloalkyl; with C₁₀₋₂₀ alkyl moieties being even more preferred. Among preferred dihydrocarbyl hydroxylamines are hydroxylamine freebase from BASF, hydroxylamine derivatives from Mitsui Chemicals America, Inc., N-hydroxyl bis(N-benzyl)amine available as BNX 2000 from Mayzo Inc. and Irgastab FS Products from Ciba Specialty Chemicals which contains oxidized bis(hydrogenate tallow alkyl)amine, also described as bis(N-dodecyl)N-hydroxylamine and Xenoxyl available from Avecia, Inc. and having the structure (R⁴)₂—N—O.

The dihydrocarbyl hydroxylamines, alicyclic hydroxylamines or nitrile oxides thereof are utilized in sufficient amounts to stabilize the compositions of the invention. Preferably the hydroxylamines are used in an amount of about 1 parts per million of the compositions of the invention or greater, more preferably about 2 parts per million or greater and most preferably about 5 parts per million or greater. Preferably the hydroxylamines are used in an amount of about 100,000 parts per million of the compositions of the invention or less, more preferably about 50,000 parts per million or less, even more preferably about 10,000 parts per million or less and most preferably about 3,000 parts per million or less.

### Dispensing

The two-part polymerizable compositions or adhesive compositions of the invention are uniquely suited for use with conventional, commercially available dispensing equipment for two-part compositions. Once the two-parts have been combined, the composition should be used quickly, as the useful pot life (open time) may be short depending upon the monomer mix, the amount of complex, the amount of polymerization catalyst and the temperature at which the bonding is to be performed. The adhesive compositions of the invention are applied to one or both substrates and then the substrates are joined together, preferably with pressure to force excess adhesive composition out of the bond line. In general, the bonds should be made shortly after the composition has been applied, preferably within about 20 minutes, more preferably within about 10 minutes. The typical bond line thickness is about 0.005 inches (0.13 mm) to about 0.03 inches (0.76 mm). The bond line can be thicker if gap filling is needed as the composition of the invention can function as both an adhesive and a gap filler. The bonding process can easily be carried out near or above room temperature.

The compositions may further comprise a variety of optional additives. One particularly useful additive is a thickener such as medium to high (about 10,000 to about 1,000,000) molecular weight polymethyl methacrylate which may be incorporated in an amount of about 10 to about 60 weight percent, based on the total weight of the composition. Thickeners may be employed to increase the viscosity of the composition to facilitate application of the composition.

In some embodiments, such as where a heterocyclic ring opening compound is present and is an oxirane, it may desirable to include some aziridine containing compound in the formulation as the aziridine enhances the stability of the formulation. Generally, enough aziridine is added to improve the stability of the formulation. Preferably about 1 percent by weight or greater of aziridine based on the weight of the formulation is used and more preferably about 2 percent by weight or greater. Preferably about 10 percent by weight or less of aziridine based on the formulation weight is used and more preferably about 7 percent by weight or less is used.

The composition may be substantially free of, or entirely free of solvents, such as liquid diluents (e.g., having a boiling point greater than about 20° C. and a melting point less than about 20° C.) that are not polymerizable (i.e., that are not polymerizable in the adhesive composition). For example, the composition may be free of one or any combination (e.g., all) of the solvents selected from the group consisting of saturated hydrocarbons (e.g., alkanes, cyclic alkanes, and the like), alkanols, aryls (e.g., alkyl phenyls, alkyl xylyls, alkyl benzyls, benzene, xylene, toluene, and the like), and alkanones. If present the concentration of solvent may be less than about 50 weight percent, preferably about 20 weight percent or less, more preferably about 5 weight percent or less, and most preferably about 1 weight percent or less, based on the total weight of the composition.

Polymerizable compositions according to the invention may be used in wide variety of ways, including as sealants, coatings, primers, to modify the surface of polymers, and injection molding resins. They may also be used as matrix resins in conjunction with glass and metal fiber mats, such as in resin transfer molding operations. They may further be used as encapsulants and potting compounds such as in the manufacture of electrical components, printed circuit boards and the like. Quite desirably, they provide polymerizable adhesive compositions that can bond a diverse myriad of substrates, including polymers, wood, ceramics, concrete, glass and primed metals. Another desirable related application is their use in promoting adhesion of paints to low surface energy substrates such as polyethylene, polypropylene, polyethyleneterephthalate, polyamides, and polytetrafluoroethylene, and their co-polymers. In this embodiment the composition may be coated onto the surface of the substrate to modify the surface to enhance the adhesion of the final coating to the surface of the substrate or added to the coating itself.

The compositions of the invention can be used in coating applications. In such applications the composition may further comprise a carrier such as a solvent. The coating may further contain additives well known to those skilled in the art for use coatings, such as pigments to color the coating, inhibitors and UV stabilizers. The compositions may also be applied as powder coatings and may contain the additives well known to those skilled in the art for use in powder coatings. The compositions are applied to the surface of the substrate and allowed to cure on the surface of the substrate.

The compositions of the invention can also be used to modify the surface of a polymeric molded part, extruded film or contoured object. Compositions of the invention can also be used to change the functionality of a polymer particle by surface grafting of polymer chains on to the unmodified plastic substrate.

### Surfaces

Polymerizable compositions of the invention are especially useful for adhesively bonding low surface energy plastic or polymeric substrates that historically have been very difficult to bond without using complicated surface preparation techniques, priming, etc. By low surface energy substrates is meant materials that have a surface energy of about 45 mJ/m² or less, preferably about 40 mJ/m² or less, more preferably about 37 or less, even more preferably about 35 or less, and most preferably about 32 mJ/m² or less. Included among such materials are polyethylene, polypropylene, thermoplastic polyolefins (TPO), acrylonitrile-butadiene-styrene, polyamides, syndiotactic polystyrene, olefin containing block co-polymers, and fluorinated polymers such as polytetrafluoroethlene (TEFLON™) which has a surface energy of less than about 20 mJ/m². (The expression “surface energy” is often used synonymously with “critical wetting tension” by others.) Other polymers of somewhat higher surface energy that may be usefully bonded with the compositions of the invention include polycarbonate, polymethylmethacrylate, and polyvinylchloride. Combinations of materials may also be adhesively bonded with the present invention.

High crystallinity materials include those comprising polyamides, polyesters or the like. Preferably, materials that are majority polyamide may be bonded with the present invention. More preferred materials include Nylon 6, Nylon 6,6, and glass fiber filled Nylons; other preferred materials include a blend of syndiotactic polystyrene (SPS) and a nylon ranging from about 50 to about 99 percent nylon (e.g., Questra B commercially available from Dow Chemical Co.). In one embodiment, the adhesives of the present invention are useful to bond SPS/nylon blends to themselves, nylon 6 to itself, or Nylon 6,6 to itself.

Thermoplastic polyolefins (i.e., thermoplastics which contain semi-crystalline polypropylene and an ethylene containing elastomer) may also be bonded with the polymerizable compositions. The elastomer in the thermoplastic elastomer may be a copolymer or terpolymer of ethylene and an alpha-olefin having from 3 to 12 carbon atoms. Terpolymers of ethylene may contain as a third monomer a diene at a concentration of less than about 10 mole percent (e.g., the ethylene containing elastomer may be an EPDM rubber including ethylene, propylene and a diene). Suitable elastomers may contain from about 20 mole percent to about 85 mole percent ethylene. The thermoplastic polyolefin may contain elastomer at a concentration of about 5 weight percent or more, preferably about 10 weight percent or more, more preferably about 15 weight percent elastomer or more, and most preferably about 18 weight percent or more based on the total weight of the thermoplastic polyolefin. The thermoplastic polyolefin may contain elastomer at a concentration less than about 50 weight percent, preferably less than 45 weight percent, more preferably less than 40 weight percent, and most preferably less than 35 weight percent based on the total weight of the thermoplastic polyolefin (e.g., about 20 weight percent or less). The polyolefin may contain semi-crystalline polypropylene (i.e. polypropylene homopolymer or copolymer containing isotactic polypropylene and having a crystallinity greater than about 50 weight percent, preferably greater than 60 weight percent based on the total weight of the semi-crystalline polypropylene as measured by differential scanning calorimetry) present at a concentration greater than about 48 weight percent, preferably greater than 55 weight percent, more preferably greater than 58 weight percent, and most preferably greater than about 63 weight percent based on the total weight of the thermoplastic polyolefin.

One exemplary TPO is a thermoplastic polyolefin sold under the name T702-12N Polypropylene Resin DA by Dow Chemical Company characterized by an elastomer concentration from about 20 to about 40 weight percent (e.g., about 32 weight percent), a flexural modulus of less than about 1500 MPa (preferably less than about 1300 MPa, even more preferably less than about 1200 MPa, and most preferably less than about 1180 MPa) as measured according to ISO 178 at a rate of 2 mm/min, and a melt flow rate from about 5 to about 30 g/10 min (e.g., from 12 to about 15 g/10 min) as measured by ISO 1133 at 230° C. and 2.16 kg.

### Two-Part Adhesives

The polymerizable compositions of the invention can be easily used in an adhesive system including two or more parts (e.g., as a two-part adhesives). The components of the polymerizable compositions may be blended as would normally be done when working with such materials, with one or more components being blended in only the first part, one or more components being blended in only the second part, and optionally one or more components being apportioned and blended in both the first part and the second part. The decomplexing agent and the organoborane amine complex are typically included in different parts of the composition. The apportionment of the other components between the first part and the second part may be determined by the function of the component (e.g., a stabilizer for the organoborane will typically be included in the part containing the organoborane, and a hydroquinone (e.g., an alkyl ether of a hydroquinone, such as methyl ether of hydroquinone) will typically be included in the part containing the decomplexing agent), the reactivity of the component with other components, the concentration of the component, and the desire to achieve a particular ratio of the volume of the first and second part (e.g., the components may be apportioned to achieve a mix ratio of 10:1, 4:1, 3:1, 2:1, 1:1, and the like). Some compounds which undergo free radical polymerization may be added to either or both parts of the two-part composition. Other compounds which undergo free radical polymerization may be added only to the part containing the decomplexing agent (e.g., in the case of a composition containing propoxylated tetrahydrofurfuryl methacrylate and TNBB/MOPA, it may be desirable for the propoxylated tetrahydrofurfuryl methacrylate to be added only to the part containing the decomplexing agent). Many compounds which undergo free radical polymerization, such as methyl methacrylate, methacrylate terminated polybutadiene oligomers, and glycidyl methacrylate may usually be added to either part. Fillers may typically be added to either part and may be an effective means of achieving the desired mix ratio. When choosing which part to add a filler, it may be important to consider the type of filler, any surface treatment or other modification of the filler, and the other components in each part

The components may be added individually or any two or more of the components may be precompounded. As such, the monoalkenyl arene block copolymer (e.g., the styrene-butadiene-styrene triblock copolymer) may be precompounded with one or more of the compounds which may undergo free radical polymerization (e.g., all of the monoalkenyl arene block copolymer in the composition may be precompounded with some, or preferably all of the methyl methacrylate in the composition).

For a two-part adhesive such as those of the invention to be most easily used in commercial and industrial environments, the volume ratio at which the two-parts are combined should be a number (typically a whole number). This facilitates application of the adhesive with conventional, commercially available dispensers. Such dispensers are shown in U.S. Pat. Nos. 4,538,920 and 5,082,147 (incorporated herein by reference) and are available from Conprotec, Inc. (Salem, N.J.) under the trade name MIXPAC. Typically, these dispensers use a pair of tubular receptacles arranged side-by-side with each tube being intended to receive one of the two-parts of the adhesive. Two plungers, one for each tube, are simultaneously advanced (e.g., manually or by a hand-actuated ratcheting mechanism) to evacuate the contents of the tubes into a common, hollow, elongated mixing chamber that may also contain a static mixer to facilitate blending of the two-parts. The blended adhesive is extruded from the mixing chamber onto a substrate. Once the tubes have been emptied, they can be replaced with fresh tubes and the application process continued.

The ratio at which the two-parts of the adhesive are combined may controlled by the cross-sectional area, or the diameter of the tubes. (Each plunger is sized to be received within a tube of fixed diameter, and the plungers are advanced into the tubes at the same speed.) A single dispenser is often intended for use with a variety of different two-part adhesives and the plungers are sized to deliver the two-parts of the adhesive at a convenient mix ratio. The mix ration is preferably less than about 10:1, more preferably less than about 4:1 and most preferably about 1:1.

Preferably the mixed two-part compositions of the invention have a suitable viscosity to allow application without dripping. Preferably, the viscosities of the two individual components should be of the same order or magnitude. Preferably the mixed compositions have the viscosity of about 100 (0.1 Pas) centipoise or greater, more preferably about 1,000 (1.0 Pa·s) centipoise or greater and most preferably about 5,000 (5.0 Pa·s) centipoise or greater. Preferably the adhesive compositions have a viscosity of about 1,000,000 (1000 Pa·s) centipoise or less, more preferably about 500,000 (500 Pa·s) centipoise or less and most preferably about 30,000 (30 Pa·s) centipoise or less.

### Examples

The following examples are included for illustrative purposes only and are not intended to limit the scope of the claims. Unless otherwise stated all parts and percentages are by weight.

Ingredients

The following ingredients were used in the examples provided hereinafter:

methyl methacrylate available from Rohm and Haas;

styrene-butadiene-styrene triblock block copolymer available from Dexco Polymers under the trademark and designation VECTOR 2518;

fumed silica having a B.E.T. surface area of about 115 m/g and less than 1 weight percent residue on a 44 micron screen available from Cabot Corporation under the trademark and designation CAB-O-SIL TS-720;

methacrylate-butadiene-styrene block copolymer from Rohm and Haas Company under the trademark and designation PARALOID BTA-753;

a tetrahydrofurfuryl methacrylate available from Sartomer Company under the designation of SR-203 and corresponds to the formula

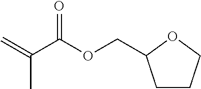

glycidyl methacrylate available from Sartomer Company under the designation SR-379 and corresponds to the formula

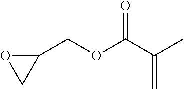

a propoxylated tetrahydrofurfuryl acrylate available from Sartomer Company under the designation CD-611 and corresponds to the formula,

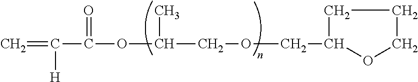

IRGASTAB™ FS301 a mixture of oxidized bis(hydrogenated tallow alkyl)amines(bis(N-dodecyl)N-hydroxylamine and Tris(2,4-ditert-butyl phenol) phosphite available from Ciba Specialty Chemicals;

a complex of tri-n-butyl borane and methoxypropyl amine (TNBB/MOPA);

methyl ether of hydroquinone (MEHQ);

acrylic acid;

methyl acrylic acid;

a chlorosulfonated polyethylene synthetic rubber available form DuPont Performance Elastomers under the trademark and designation Hypalon® 20;

a methacrylate terminated butadiene homopolymer having a Brookfield Viscosity from about 30,000 to about 600,000 centipoise measured at 27° C., a glass transition temperature less than about −40° C. and an acid number from about 0 to about 6 available from Emerald Performance Materials under the tradename and designation Hypro™ VTB 2000X168;

a surface treated precipitated calcium carbonate available from Shiraishi Calcium under the designation Homocal G50.

Blends of the Hypalon® 20 with methyl methacrylate and Vector™ 2518 with methyl methacrylate, SR-203, SR-379 and CD-611 are prepared using the concentrations given in Table 1. These blends, B1, B2, B3, B4, and B5 are then used in preparing two part adhesive formulations.

TABLE 1
Formulations of monomer/polymer blends

| | B1 | B2 | B3 | B4 | B5 |
|---|---|---|---|---|---|
| Polymer | | | | | |
| Hypolon 20 | 40 | | | | |
| Vector 2518 | | 25 | 25 | 25 | 25 |
| Monomer | | | | | |
| Methylmethacrylate | 60 | 75 | | | |
| SR-203 | | | 75 | | |
| SR-379 | | | | 75 | |
| CD-611 | | | | | 75 |
| Total | 100 | 100 | 100 | 100 | 100 |

A comparative sample, CTR-1, containing methyl methacrylate is prepared using the concentration given in Table 2 for the part A and part B of this two part composition. Part A and Part B of this composition are mixed together at a 1:1 ratio and lap shear test specimens are prepared using substrates of a grade TPO (Dow T702-12N Polypropylene Resin DA available from Dow Chemical Company), an overlapped bond area of about 25.4 mm×25.4 mm and a bondline thickness of about 254 μm (10 mil). The lap shear strength is measured after 6 days at a temperature of about 20° C. The specimen have adhesive failure and the lap shear strength results are shown in Table 2.

Three samples, EX.1-2, and CTR-2 are prepared according to the compositions in TABLE 2, using three different monomers instead of the methyl methacrylate. The samples are mixed and tested in the same manner as CTR-1. The results of the lap shear strength is given in TABLE 2. EX.1-2 have superior adhesion and fail by boundary fail mode and/or substrate failure mode. CTR-2 contains the borane compound and the CD-611 in the same part which react and gels prior to preparing the test sample.

Three samples, EX.3-5, containing at least two different monomers are prepared according to the compositions in TABLE 3. The samples are mixed and tested in the same manner as CTR-1. The results of the lap shear strength and the adhesion failure modes are given in TABLE 3.

A comparative sample, CTR-3, containing methyl methacrylate and both Hypalon 20 and Vector 2518 is prepared according to the part A and part B compositions given in TABLE 4. A sample, EX. 6, containing at least three monomers and Vector 2518, but free of Hypalon 20, is prepared according to the part A and part B compositions given in TABLE 4. CTR-3 and EX.6 are mixed and tested in the same manner as CTR-1. The results of the lap shear strength and the adhesion failure modes are given in TABLE 5.

EX.7-9 are prepared using the same composition as EX.6. The compositions for these samples are given in TABLE 6. The samples are mixed and tested in the same manner as CTR-1. Additional lap shear samples are tested after 2 weeks and after 3 weeks at about 20° C. The results of the lap shear strength and the adhesion failure modes are given in TABLE 6.

It should be understood that various ingredients may be substituted, added, or removed from the above formulations without departing from the scope of the present invention. Moreover, it is contemplated that the weight percentages of the above ingredients and the values of the properties listed may vary up to or greater than 5 percent, 10 percent, 25 percent, or 50 percent of the values listed. For example, a value of 10 may vary by 10 percent, which may result in a range of about 9 to about 11.

TABLE 2

| | CTR-1 | EX. 1 | EX. 2 | CTR-2 |
|---|---|---|---|---|
| PART A | | | | |
| B2 (25% Vector 2518/75% MMA) | 30.3 | | | |
| B3 (25% Vector 2518/75% | | 30.3 | | |
| SR-203) | | | | |
| B4 (25% Vector 2518/75% | | | 30.3 | |
| SR-379) | | | | |
| B5 (25% Vector 2518/75% | | | | 30.3 |
| CD-611) | | | | |
| MMA | 40.4 | | | |
| SR-203 | | 40.4 | | |
| SR-379 | | | 40.4 | |
| CD-611 | | | | 40.4 |
| Paraloid BTA 753 | 19.0 | 19.0 | 19.0 | 19.0 |
| Acrylic Acid | 10.1 | 10.1 | 10.1 | 10.1 |
| MEHQ | 0.2 | 0.2 | 0.2 | 0.2 |
| | 100.0 | 100.0 | 100.0 | 100.0 |
| Glass Beads (10 mil) | 1.0 | 1.0 | 1.0 | 1.0 |
| PART B | | | | |
| Monomer/Polymer Blend | | | | |
| B2 (25% Vector 2518/75% MMA) | 30.3 | | | |
| B3 (25% Vector 2518/75% | | 30.3 | | |
| SR-203) | | | | |
| B4 (25% Vector 2518/75% | | | 30.3 | |
| SR-379) | | | | |
| B5 (25% Vector 2518/75% | | | | 30.3 |
| CD-611) | | | | |
| MMA | 40.4 | | | |
| SR-203 | | 40.4 | | |
| SR-379 | | | 40.4 | |
| CD-611 | | | | 40.4 |
| Paraloid BTA 753 | 19.0 | 19.0 | 19.0 | 19.0 |
| TNBB/MOPA | 10.1 | 10.1 | 10.1 | 10.1 |
| Irgastab FS 301FF | 0.2 | 0.2 | 0.2 | 0.2 |
| | 100.0 | 100.0 | 100.0 | 100.0 |
| Glass Beads (10 mil) | 1.0 | 1.0 | 1.0 | 1.0 |
| Aged 6 days at room temperature | | | | |
| Lap Shear Strength (ASTM 3163), | | | | |
| MPa | | | | |
| Specimen 1 | 1.05 | 2.17 | 2.16 | Gelled |
| Specimen 2 | 1.50 | 2.08 | 2.20 | Gelled |
| Failure Mode (Worst: AF = | | | | |
| adhesive; BF = boundary; Best: | | | | |
| SF = substrate or CF = | | | | |
| cohesive) | | | | |
| Specimen 1 | AF | BF | BF | |
| Specimen 2 | AF | BF | SF | |

TABLE 3

| | EX. 3 | EX. 4 | EX. 5 |
|---|---|---|---|
| PART A | | | |
| B2 (25% Vector 2518/75% MMA) | | 31.5 | 31.5 |
| B3 (25% Vector 2518/75% SR-203) | 31.5 | | |
| SR-203 | | | 42.0 |
| SR-379 | 42.0 | 42.0 | |
| Paraloid BTA 753 | 15.8 | 15.8 | 15.8 |
| Acrylic Acid | 10.5 | 10.5 | 10.5 |
| MEHQ | 0.2 | 0.2 | 0.2 |
| | 100.0 | 100.0 | 100.0 |
| Glass Beads (10 mil) | 1.0 | 1.0 | 1.0 |
| PART B | | | |
| B2 (25% Vector 2518/75% MMA) | | 31.5 | 31.5 |
| B3 (25% Vector 2518/75% SR-203) | 31.5 | | |
| SR-203 | | | 42.0 |
| SR-379 | 42.0 | 42.0 | |
| Paraloid BTA 753 | 15.8 | 15.8 | 15.8 |
| TNBB/MOPA | 10.5 | 10.5 | 10.5 |
| Irgastab FS 301FF | 0.2 | 0.2 | 0.2 |
| | 100.0 | 100.0 | 100.0 |
| Glass Beads (10 mil) | 1.0 | 1.0 | 1.0 |
| Aged 6 days at room temperature | | | |
| Lap Shear Strength (ASTM 3163), MPa | | | |
| Specimen 1 | 2.18 | 2.22 | 2.19 |
| Specimen 2 | 2.18 | 2.25 | 2.21 |
| Specimen 3 | 2.23 | 2.17 | 2.22 |
| Failure Mode | | | |
| Specimen 1 | AF | SF | BF |
| Specimen 2 | SF | SF | BF |
| Specimen 3 | BF | SF | BF |

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the

TABLE 4

| | CTR-3 | EX. 6 |
|---|---|---|
| PART A | | |
| Monomer/Polymer Blend | | |
| B1 (40% Hypalon 20/60% MMA) | 23.3 | |
| B2 (25% Vector 2518/75% MMA) | 50.7 | 30.8 |
| MMA | 16.2 | |
| SR-379 | | 36.0 |
| CD-611 | | 5.2 |
| Hypro 2000 × 168 | | 5.2 |
| Paraloid BTA 753 | | 5.2 |
| Acrylic Acid | | 5.2 |
| Methyl acrylic acid | 9.5 | |
| Homocal G50 | | 10.3 |
| Cab-o-sil TS 720 | | 2.0 |
| MEHQ | 0.3 | 0.1 |
| | 100.0 | 100.0 |
| Glass Beads (10 mil) | 1.0 | 1.0 |
| PART B | | |
| Monomer/Polymer Blend | | |
| B2 (25% Vector 2518/75% MMA) | | 31.5 |
| MMA | 66.5 | |
| SR-379 | | 42.0 |
| Paraloid BTA 753 | 23.7 | 15.8 |
| TNBB/MOPA | 9.5 | 10.5 |
| Irgastab FS 301FF | 0.3 | 02 |
| | 100.0 | 100.0 |
| Glass Beads (10 mil) | 1.0 | 1.0 |
| Aged 6 days at room temperature | | |
| Lap Shear Strength (ASTM 3163), MPa | | |
| Specimen 1 | 0.65 | 2.09 |
| Specimen 2 | 1.03 | 2.14 |
| Specimen 3 | | 2.17 |
| Failure Mode | | |
| Specimen 1 | AF/BF | SF |
| Specimen 2 | AF/BF | SF |
| Specimen 3 | | SF |
| Wedge Test, ASTM 3762, kg | | |
| Specimen 1 | CF/BF/AF | AF |

TABLE 5

| | EX. 7 | EX. 8 | EX. 9 |
|---|---|---|---|
| PART A | | | |
| Monomer/Polymer Blend | | | |
| B2 (25% Vector 2518/75% MMA) | 30.8 | 30.8 | 30.8 |
| SR-379 | 36.0 | 36.0 | 36.0 |
| CD-611 | 5.2 | 5.2 | 5.2 |
| Hycar 2000 × 168 | 5.2 | 5.2 | 5.2 |
| Paraloid BTA 753 | 5.2 | 5.2 | 5.2 |
| Acrylic Acid | 5.2 | 5.2 | 5.2 |
| Homocal G50 | 10.3 | 10.3 | 10.3 |
| Cab-o-sil TS 720 | 2.0 | 2.0 | 2.0 |
| MEHQ | 0.1 | 0.1 | 0.1 |
| | 100.0 | 100.0 | 100.0 |
| Glass Beads (10 mil) | 1.0 | 1.0 | 1.0 |
| PART B | | | |
| Monomer/Polymer Blend | | | |
| B2 (25% Vector 2518/75% MMA) | 31.5 | 31.5 | 31.5 |
| SR-379 | 42.0 | 42.0 | 42.0 |
| Paraloid BTA 753 | 15.8 | 15.8 | 15.8 |
| TNBB/MOPA | 10.5 | 10.5 | 10.5 |
| Irgastab FS 301FF | 0.2 | 0.2 | 0.2 |
| | 100.0 | 100.0 | 100.0 |
| Glass Beads (10 mil) | 1.0 | 1.0 | 1.0 |

fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

TABLE 6

| | EX. 7 | | EX. 8 | | EX. 9 | |
|---|---|---|---|---|---|---|
| Lap Shear Strength, | Strength | | Strength | | Strength | |
| ASTM 3163 | Mpa | Failure Mode | Mpa | Failure Mode | Mpa | Failure Mode |
| Aged 6 days at 20° C. | | | | | | |
| Specimen 1 | 4.08 | SF | 3.99 | SF | 3.96 | SF |
| Specimen 2 | 4.08 | SF | 4.04 | CF/AF(95/15) | 3.93 | SF |
| Specimen 3 | 4.00 | SF | 4.05 | CF/AF(90/10) | 3.81 | SF |
| Aged 2 weeks at 20° C. | | | | | | |
| Specimen 1 | 4.19 | SF | 3.98 | SF | 4.11 | SF |
| Specimen 2 | 4.10 | SF | 3.95 | SF | 4.05 | SF |
| Specimen 3 | 4.05 | SF | 3.98 | CF/AF(50/50) | 3.97 | SF |
| Aged 3 weeks at 20° C. | | | | | | |
| Specimen 1 | 4.01 | SF | 3.85 | SF | 3.87 | SF |
| Specimen 2 | 3.92 | SF | 3.95 | SF | 3.85 | SF |
| Specimen 3 | 3.99 | CF/AF(50/50) | 3.95 | CF/AF(96/4) | 3.79 | SF |
| Wedge Test. ASTM 3762 | kg | Failure Mode | kg | Failure Mode | kg | Failure Mode |
| Aged 6 days at 20° C. | | | | | | |
| Specimen 1 | 10.0 | CF/AF(90/10) | 17.3 | CF/BF(95/5) | 8.6 | CF/BF(85/15) |
| Specimen 2 | 8.6 | CF/AF(90/10) | 8.2 | CF | 7.7 | CF |
| Specimen 3 | 6.4 | CF/AF(50/50) | 5.5 | CF/BF(85/15) | 4.5 | CF |
| Aged 2 weeks at 20° C. | | | | | | |
| Specimen 1 | 6.8 | CF | 8.6 | CF | 6.4 | CF |
| Specimen 2 | 5.5 | CF | 5.0 | CF | 5.5 | CF |
| Specimen 3 | 5.0 | CF | 2.7 | CF/AF(50/50) | 4.1 | CF |
| Aged 3 weeks at 20° C. | | | | | | |
| Specimen 1 | 7.7 | CF | 9.1 | CF | 6.8 | CF |
| Specimen 2 | 7.3 | CF | 4.1 | CF | 6.4 | CF |
| Specimen 3 | 6.8 | CF | 4.1 | CF | 5.9 | CF |

1. A polymerizable adhesive composition comprising:
(i) an organoboron compound capable of forming a free radical generating species;
(ii) an organic acid;
(iii) one or more compounds that undergo a free radical polymerization; and
(iv) a monoalkenyl arene block copolymer;
wherein the one or more compounds that undergo a free radical polymerization optionally includes methyl methacrylate at a concentration less than about 80 percent based on the total weight of the compounds that undergo a free radical polymerization;
wherein the monoalkenyl arene block copolymer is present at a concentration greater than about 3 wt percent, based on the total weight of the polymerizable adhesive composition, and the monoalkenyl arene block copolymer has one or more blocks including a monoalkenyl arene and one or more blocks including a conjugated diene; and
wherein the adhesive composition upon curing for 6 days at about 20° C. when applied to a thermoplastic polyolefin exhibits a lap shear strength greater than about 1.8 MPa tested according to ASTM 3163 with a bondline of about 254 μm.

2. A polymerizable adhesive composition of claim 1, wherein the adhesive composition is a two-part adhesive composition wherein the two-part adhesive includes a first part and a second part; the organoboron compound is in the first part; the organic acid is in the second part; the one or more compounds that undergo a free radical polymerization is in the first part, the second part, or both; and the monoalkenyl arene block copolymer is in the first part, the second part, or both.

3. A polymerizable adhesive composition of claim 1 wherein the composition comprises two or more compounds that undergo a free radical polymerization.

4. A polymerizable adhesive composition of claim 3 wherein the two or more compounds that undergo a free radical polymerization includes two or more compounds which are esters of unsaturated carboxylic acids, wherein the esters of unsaturated carboxylic acids each have at least one acrylate or methacrylate functional group.

5. A polymerizable adhesive composition of claim 1 wherein the methyl methacrylate is present at a concentration of less than about 60 wt percent based on the total weight of the compounds that undergo a free radical polymerization.

6. (canceled)

7. (canceled)

8. A polymerizable adhesive composition of claim 1, wherein the polymerizable composition further comprises a plurality of fillers including a talc, a calcium carbonate, a fumed silica, or any combination thereof; and the plurality of fillers are present at a concentration from about 0 weight percent to about 25 weight percent based on the total weight of the polymerizable composition.

9. A polymerizable adhesive composition of claim 1 wherein the organoboron compound is an organoborane amine complex or an organoborate salt.

10. A polymerizable adhesive composition of claim 9, wherein the organoboron compound is an organoborane amine complex comprising a trialkyl borane or an alkyl cycloalkyl borane.

11. (canceled)

12. A polymerizable adhesive composition of claim 1, wherein the monoalkenyl arene block copolymer includes an A-B-A triblock copolymer, an A-B diblock copolymer, or a combination thereof wherein the total concentration of the diblock and triblock copolymer ranges from about 4 weight percent to about 20 weight percent based on the total weight of the composition.

13. (canceled)

14. A polymerizable adhesive composition of claim 2, wherein
the organoboron compound is present from about 1 to about 10 weight percent based on the total weight of the composition;
the organoboron compound includes a complex of tri-n-butyl borane and methoxypropyl amine, a complex of triethylborane and methoxypropyl amine, or both;
the organic acid is present from about 1 to about 8 weight percent based on the total weight of the composition;
the second part includes from about 2 to about 15 weight percent filler based on the total weight of the composition;
the second part includes an alkoxylated tetrahydrofurfuryl;
the second part includes methyl ether of hydroquinone, the organic acid is acrylic acid, methacrylic acid, or both;
the filler includes calcium carbonate, talc, clay, fumed silica or any combination thereof;
the methyl methacrylate is present at a concentration from about 10 to about 40 weight percent based on the total weight of the composition;
the first part, the second part, or both includes from about 10 to about 50 weight percent of a methacrylate having an oxirane ring based on the total weight of the composition, and from about 0 to about 15 weight percent of a polybutadiene oligomer having a terminal acrylate functionality based on the total weight of the composition;
the monoalkenyl arene block copolymer includes a styrene-butadiene-styrene triblock copolymer present at a concentration from about 5 to about 25 weight percent based on the total weight of the composition; and
the methyl methacrylate is present at a concentration less than about 40 weight percent based on the total weight of the methyl methacrylate, the alkoxylated tetrahydrofurfuryl acrylate, the methacrylate having an oxirane ring, and the polybutadiene oligomer having a terminal acrylate functionality.

15. A polymerizable adhesive composition of claim 1, wherein the composition optionally includes a solvent, wherein the concentration of the solvent, if present, is less than about 20 wt. % based on the total weight of the composition.

16. A polymerizable adhesive composition of claim 1, wherein
the composition is a one-part adhesive composition;
the one or more compounds that undergo a free radical polymerization includes one or more ester of an unsaturated carboxylic acid, and from about 1 to about 10 weight percent based on the total weight of the composition of a polybutadiene oligomer having a terminal acrylate functionality; and
the organoboron compound includes an organoborane amine complex.

17. A method of polymerization comprising contacting the components of the polymerization composition of claim 1 under conditions such that the compounds capable of free radical polymerization undergo polymerization.

18. A method of claim 17 wherein the polymerization occurs at an ambient temperature.

19. A method of claim 18 wherein the process further comprises a step of heating the composition.

20. A method of bonding together a first substrate and a second substrate which comprises:
i) contacting the first part and the second part of any of the two-part composition of claim 2 under conditions such that polymerization is initiated;
ii) contacting the adhesive composition with the first and second substrate;
iii) positioning the first and second substrates such that the composition is interposed between the substrates;
iv) allowing the composition to polymerize so as to bind the substrates together;
wherein the first substrate, the second substrate, or both comprises a thermoplastic having a flexural modulus less than about 1200 MPa as measured according to ISO 178 at a rate of 2 mm/min.

21. A method of coating a TPO substrate comprising the steps of contacting the components of the composition of claim 2; contacting the contacted composition with one or more surfaces of a substrate; and allowing the contacted composition to cure on the surface of the substrate.

22. A coating composition which comprises the composition of claim 1.

23. A laminate comprising at least two substrates having disposed between the substrates and bound to each substrate a composition of claim 1.

24. A method of modifying the surface of a low energy polymer comprising the steps of: contacting a composition of claim 1 with at least a portion of the surface of the low surface energy polymer; and causing the organoboron compound to convert to a free radical generating species thereby initiating a polymerization of at least one compound in the composition such that the polymer formed is on the surface of the low surface energy polymer.
